(19) United States
(12) Patent Application Publication
(10) Pub. No.: US 2014/0238216 A1
(43) Pub. Date: Aug. 28, 2014

(54) DRUM PRACTICE DEVICE AND METHOD FOR PRODUCING THE SAME

(71) Applicant: Heimback GmbH & Co. KG, Dueren (DE)

(72) Inventor: Fabrizio MINO, Borriana (BI) (IT)

(73) Assignee: Heimbach GmbH & Co. KG, Dueren (DE)

(21) Appl. No.: 14/190,412

(22) Filed: Feb. 26, 2014

(30) Foreign Application Priority Data
Feb. 26, 2013 (EP) 13156824.8

(51) Int. Cl. G10D 13/02

(52) U.S. Cl. CPC G10D 13/029
USPC 84/411 P; 264/236; 427/289; 156/242

(57) ABSTRACT

The invention relates to a drum practice device (1) with a drum pad (5) having a drum layer (6) made of a resilient material with a planar playing surface (7) on its upper side, wherein the drum pad (5) comprises a felt layer (8) disposed beneath the drum layer (6). Furthermore, the invention relates to a method for producing a drum practice device (1) comprising the steps of providing a felt layer (8), providing a mold with a shape that corresponds to the contour of the felt layer (8), the mold having a height that exceeds the thickness of the felt layer (8), positioning the felt layer (8) within the mold, pouring a given amount of a liquefied resilient material, particularly liquefied silicone onto the felt layer (8) positioned within the mold, vulcanizing the resilient material, removing the mold.

### CROSS-REFERENCE TO RELATED APPLICATIONS AND CLAIM TO PRIORITY

This application is related to application number 13 156 824.8, filed Feb. 26, 2013, in the European Patent Office, the disclosure of which is incorporated herein by reference and to which priority is claimed.

### FIELD OF THE INVENTION

The invention relates to a drum practice device with a drum pad having a drum layer made of a resilient material with a planar playing surface on its upper side. The invention is further directed to a method for producing a drum practice device.

### BACKGROUND OF THE INVENTION

For drummers or percussionists it is very helpful to have an implement other than the drum itself, on which they can practice technical exercises, musical literature or warm up before a music session. Such a drum practice device should on one hand allow the musician to practice quietly in comparison with a real drum so that the musician can use the drum practice device in an everyday environment, for example in his flat or in a hotel room, without disturbing people nearby. On the other hand, the device should simulate the feeling of playing a real drum as natural and realistic as possible, to serve as a convenient substitute.

Such drum practice devices usually comprise a drum pad having a drum layer made of a resilient material with a planar playing surface on its upper side, which the musician hits with his drum sticks like he would hit the playing surface of a real drum.

Drum practice devices of this kind are known from the state of the art in different embodiments. One embodiment of a drum practice device is disclosed in U.S. Pat. No. 5,929,354. Here, the drum practice device has a drum pad consisting of a single drum layer made of silicone. For practicing, the drummer or percussionist positions the silicone drum pad on a flat surface, for example the surface of a table, and hits the upper surface of the drum pad, i.e, the playing surface, with his drum sticks. A disadvantage of the drum practice device is that when the musician hits the drum pad, the bounce will be quite different to that of real drum. He will particularly need more force than for a real drum and therefore runs the risk of overstressing his arms and/or wrists.

In U.S. Pat. No. 4,179,974 a further drum practice device is disclosed, which is formed by a drum pad comprising a rectangular drum layer made of gum rubber. The drum layer is affixed with an adhesive on the upper side of a rectangular metal plate, which serves as a support layer. On the lower side of the metal plate another layer made of gum rubber is provided, which is lightly roughened on its lower side to ensure an advanced gripping-ability of the drum practice device. The gripping abilities of this drum practice device are improved in comparison to the aforementioned embodiment but the drum feeling of the drum pad comprising a gum rubber layer and a metal support plate is not improved.

Another embodiment of a drum practice device is described in U.S. Pat. No. 6,362,407 B1. This device also comprises a drum pad with layer of gum rubber serving as the drum layer. The drum layer is affixed to the upper side of a round wooden plate. Furthermore, there are sound insulating cushions affixed to the lower side of the wooden plate. The sound insulating cushions include a circular piece of resilient support material, which serves as a bottom or foot of the cushion. With the use of the sound insulating cushions the drum pad is supported in an acoustically-floating manner and the vibrations induced by hitting the drum pad will not be transferred to a surface, the drum practice device is positioned on. Nevertheless, the use of a wooden support layer instead of a metal one does not result in an improved drum feeling.

With the further drum practice device according to GB 2 473 832 A this problem has also not been overcome. The drum practice device described therein also has a drum pad with a drum layer made of rubber, which is positioned on a wooden support plate. The drum feeling of this device will therefore be the same as the drum feeling of the aforementioned embodiment.

All the drum practice devices known from the state of the art have the disadvantage that the drum feeling significantly varies from that of a real drum and due to this the musician does not have ideal practice conditions. The musician particularly has to exert an increased amount of force during the use of the device and therefore might overstress his wrists or might even get injured.

### SUMMARY OF THE INVENTION

It is therefore an object of the present invention to provide a drum practice device, which simulates the feeling of playing a drum in a more realistic way.

According to the present invention, this object is solved by a drum practice device of the aforementioned kind, wherein the drum pad further comprises a felt layer disposed beneath the drum layer. It has turned out that the combination of a drum layer made of a resilient material with a layer made of felt, which is positioned beneath the drum layer, leads to a drum practice device, which provides a unique combination of at least two qualities. On the one hand the drum feeling is simulated in a very realistic and natural way when the musician hits the drum layer of the drum pad with his drum sticks. He experiences a very good and reliable bounce. Also, the amount of force the musician has to exert during use of the drum practice device, is very close to the amount of force needed with a real drum. On the other hand the sound and the vibrations, which are created due to the impact of the drum sticks on the resilient drum layer are optimally dampened by the felt layer, which is disposed beneath the drum layer. The vibrations will therefore not be transferred to the musician's arms and as a result, hand, wrist and forearm fatigue will be prevented and the risk of injuries, especially tendinitis, will be diminished.

Furthermore, due to the good absorption and/or dampening properties of the felt layer, the sound level of the drum practice device during use is especially low. The musician can therefore practice even in an environment where other people are present or close by, because they won't be disturbed by the practice procedure on the inventive drum practice device.

According to one embodiment of the present invention the felt layer is embodied as a needle felt layer. Needle felt is especially suited because it is a robust and tough textile material. It also has good sound absorption properties.

Furthermore, the felt layer preferably comprises fibers made of polyester or polyamide. Both polyester and polyamide are materials which also have excellent properties. Fibers made of polyester or polyamide are very robust and tough as well as moisture resistant.

According to another embodiment the felt layer comprises at least one fabric layer to which at least one fiber layer is affixed, particularly needled. The felt layer can in particular be manufactured out of one or more layers of fabric, particularly polyester woven or knitted base fabric and one or more fiber layers, particularly polyester or polyamide staple fiber batts. In an especially preferred embodiment, the felt layer is made of seven layers of polyester woven base fabric and one layer of polyester staple fiber batt. A felt layer produced out of several fabric and/or fiber layers is especially suited as a felt layer for the drum pad of the inventive drum practice device.

The felt layer furthermore preferably has a thickness in the range of 5-15 mm, particularly of 8-12 mm. In the same way the drum layer preferably has a thickness in the range of 5-15 mm, particularly of 8-12 mm. These dimensions are especially suited to allow for an ideal bounce, good sound and desired amount of vibration dampening. The overall thickness of the drum pad, comprising the drum layer and the felt layer, is preferably in the range of 10 to 30 mm, more preferably in the range of 16 to 24 mm.

To increase the stability of the drum pad of the drum practice device according to the present invention, the lower side of the felt layer may be coated or impregnated with a stiffening material. For example, epoxy resin, polyurethane or silicone, particularly silicone rubber, can be used as a stiffening material. Due to the stiffening material the drum pad is especially robust. Also the tendency of the drum practice device to slide on a planar surface during use is reduced, particularly if silicone is used a stiffening material.

Increased stability of the drum pad might alternatively or in addition to the stiffening of the underside of the felt layer be achieved in that the felt layer is disposed on the upper side of a support layer which is made of a rigid material. The felt layer can then especially be affixed to the support layer, for example with the use of glue. The support layer can for example be made of wood, plastic or metal. A wooden support layer can especially be made of multi-layer wood. The support layer furthermore preferably has—in analogy to the felt layer and the drum layer—a round or a rectangular or a triangular or an octagonal contour. The support layer can especially have a contour that corresponds to that of the felt layer and the drum layer, but is slightly larger. In addition to stabilizing the drum pad, the support layer made of a rigid material will—due to its weight—also reduce the tendency of the drum practice device to slide over a surface, on which the drum practice device is positioned, for example a table.

The support layer furthermore preferably has an upwardly projecting rim, which encloses the drum pad at least partially. This embodiment is especially suited as well as aesthetically pleasing. The drum pad securely sits on the upper side of the support layer being enclosed by the rim. Furthermore, due to the rim, the optical impression of the drum practice device according to the present invention is especially uniform.

When the drum pad is enclosed by a rim, it preferably projects upwardly beyond the rim, particularly at least 2 mm. This embodiment ensures that the musician does not accidentally hit the rim, when the drum pad is hit by the drum sticks.

A further embodiment of the present invention is characterized in that the drum layer is in full-area contact with the felt layer over its entire lower surface. The full-area contact is especially advantageous for the sound dampening and vibration absorption properties of the drum pad. The full-area contact can easily be obtained for example in that the drum layer is embodied as a coating of the felt layer.

It is furthermore preferred, that the drum layer is affixed to the felt layer. If the drum layer is affixed to the felt layer, sliding of the drum layer relative to the felt layer during use of the drum practice device is prevented.

The fibers of at least the upper region of the felt layer can in particular be embedded in at least the lower region of the drum layer. The embodiment is achieved when for the manufacturing of the drum layer a liquefied resilient material is poured onto the felt layer. The liquefied resilient material will then at least partially penetrate into the felt layer. After drying or vulcanizing of the resilient material, the fibers in the upper region of the felt layer are embedded in a matrix of the material of the drum layer.

Another embodiment of the inventive drum practice device is characterized in that a further layer is disposed between the drum layer and the felt layer, and that the drum layer is disposed on the further layer. The drum pad of the drum practice device according to the present invention can of course, beyond the drum layer and the felt layer, comprise further layers of any type of material. For example a further layer made of a resilient material can be disposed between the drum layer and the felt layer, to further improve the properties of the drum pad. In this case the drum layer will not directly be positioned on the felt layer, but on the further layer and the further layer will be directly positioned on the felt layer. In the same way further textile layers can be provided. Of course the layers are then also preferably in full-area contact with each other and can be affixed to each other, especially needled or glued together or the like.

According to a further embodiment of the present invention the drum layer is made of silicone. The drum layer can then especially be made of silicone rubber. A drum layer made of silicone provides an especially good and reliable bounce. As a result, the drum feeling of the drum practice device according to the present invention is especially realistic. Furthermore, the hardness of the drum layer's material is—like the thickness—chosen to provide an ideal bounce. The hardness of the silicone preferably is in the range of 20-50 Shore A, more particularly of 30-40 Shore A. A hardness in the aforementioned range has proven to be especially suited for a good bounce.

The felt layer and the drum layer furthermore preferably have a round or a rectangular or a triangular or an octagonal contour. Particularly, the felt layer and the drum layer have identical contours. For a round embodiment, the diameter of the felt layer and the drum layer preferably are in the range of 10 to 40 cm, more preferably in the range of 15 to 35 cm.

A further object of the current invention is directed to a method for producing a drum practice device comprising the steps of providing a felt layer and a mold with a shape that corresponds to the contour of the felt layer, the mold having a height that exceeds the thickness of the felt layer, positioning the felt layer within the mold, pouring a given amount of a liquefied resilient material, particularly liquefied silicone onto the felt layer positioned within the mold, vulcanizing the resilient material, removing the mold. This method is especially suited to produce a drum pad for a drum practice device according to the present invention.

According to this embodiment, the layer of resilient material, which serves as the drum layer, can easily be produced within the framework of a casting procedure. Therefore a mold with a shape corresponding to the contour of the felt layer and an open upper side is provided, in which the felt layer is positioned. Afterwards a given amount of liquefied resilient material is poured onto the felt layer. The liquefied resilient material evenly spreads across the upper side of the felt layer, forming a layer of liquefied resilient material with an even thickness. The mold thereby prevents the liquefied resilient material, particularly the liquefied silicone, from flowing over the edge of the felt layer, when poured thereon. After the resilient material has been poured onto the felt layer, it is vulcanized. The mold can then be removed and a drum pad with two layers, i.e. the felt layer and a layer of resilient material positioned thereon, serving as the drum layer and having a contour that is identical to that of the felt layer, is produced.

When the felt layer has a round contour, the mold is formed as a ring. To prevent liquefied resilient material from spilling out of the mold, the mold has a height that exceeds the thickness of the felt layer at least by the thickness of the drum layer to be cast. The amount of liquefied resilient material to be poured onto the felt layer positioned within the mold depends on the size of the felt layer and mold and the desired thickness of the drum layer to be produced.

An alternative method for producing a drum practice device in accordance with the present invention comprises the steps of providing a felt layer, coating the felt layer with a resilient material and cutting or blanking out pieces out of the felt layer coated with the resilient material thus forming the drum pad. The felt layer can be provided as a flat felt layer, which then is coated with the resilient material. Alternatively, the felt layer is formed as an endless belt and then coated with the resilient material preferable about the entire circumference. Thereafter, the endless felt is opened by cutting it across its width thus forming a flat felt layer coated with the resilient material. In the next step, the pieces are cut or blanked out of the felt layer in any suitable shapes, particularly in a round shape.

In the methods for producing a drum practice device according to the present invention it is preferred that a further step of coating or impregnating the lower side of the felt layer with a stiffening material is carried out. The stiffening material can for example be epoxy resin, polyurethane or silicone, particularly silicone rubber.

Alternatively or in combination the further step of disposing the felt layer on the upper side of a support layer made of a rigid material might be carried out. The felt layer can then be affixed, particularly glued to the upper side of the support layer. The support layer can for example be made of wood, plastic or metal.

Preferable, the playing surface of the drum layer made of resilient material is ground at the end of the foregoing methods in order to obtain a perfectly smooth surface so to avoid friction between the drum layer and the sticks when the latter ones hit the playing surface.

A further object of the present invention is the use of a pad having a drum layer made of a resilient material with a planar playing surface on its upper side and a felt layer disposed beneath the drum layer as a drum pad for a drum practice device.

### BRIEF DESCRIPTION OF THE FIGURE(S)

In the following, the current invention is presented in detail by means of examples given in the FIGS. 1 and 2. From these figures,

FIG. 1 shows an inventive drum practice device and

FIG. 2 a cross section of the inventive drum practice device shown in FIG. 1.

### DETAILED DESCRIPTION OF THE PREFERRED EMBODIMENT(S)

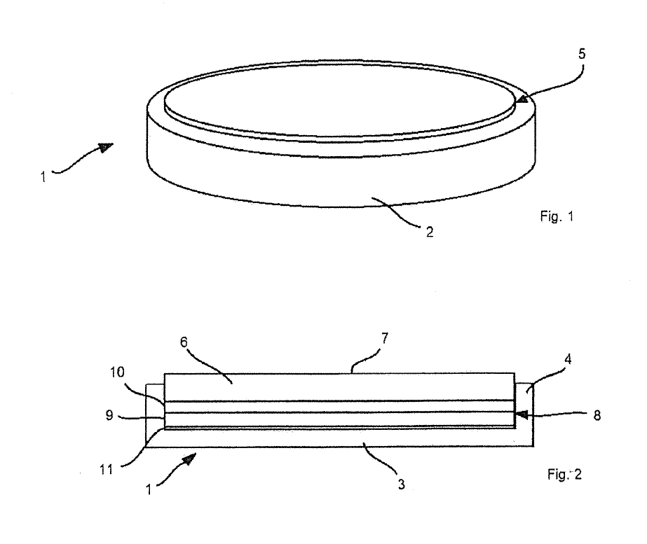

In FIG. 1 the drum practice device 1 is shown. The drum practice device 1 comprises a circular support frame 2, which is made of multi-layer wood. The wooden support frame 2 has a diameter of about 25 cm. As can be seen in FIG. 2, the wooden support frame 2 consists of a round bottom plate 3, which is about 6 mm thick, and a rim 4 which upwardly projects from the bottom plate 3. The rim 4 is about 17 mm high. The total height of the support frame is about 23 mm. The upper side of the bottom plate 3 and the inner side of the rim 4 surround a cylindrical receiving space.

The drum practice device 1 further comprises a round drum pad 5, which is positioned within the cylindrical receiving space formed by the support frame 2. The drum pad 5 is partly enclosed by the rim 4 and projects upwardly beyond the rim 4 by about 3 mm. The drum pad 5 has a diameter which is slightly less than the diameter of the wooden support frame 2 and has a thickness of about 20 mm.

As can be seen in FIG. 2, the drum pad 5 comprises a drum layer 6 with a planar playing surface 7 on its upper side. The drum layer 6 is made of resilient material, here silicone rubber with a hardness of 35 shore A and has a thickness of 10 mm.

Beneath the drum layer 6 a felt layer 8 is disposed, which is embodied as a needle felt layer 8. The felt layer 8 and the drum layer 6 are in full-area contact and affixed to each other.

The felt layer 8 consists of three sub-layers 9, 10 and 11. The middle sub-layer is a base fabric layer 9, onto which a fiber layer 10 is needled. On the lower side of the felt layer 8 a thin bottom fiber layer 11 is formed by the needling operation due to the transport of fibers through the base fabric layer 9 from the top to the bottom. The thickness of the fiber layer 10 is about 4 mm and the thickness of the bottom fiber layer 11 about 1 mm. The thickness of the base fabric layer 9 is 5 mm, resulting in a total thickness of the felt layer 8 of about 10 mm. The diameter of the felt layer 8 is furthermore identical to the diameter of the drum layer 6.

A drum practice device 1 as shown in FIG. 1 is manufactured as follows. First, the felt layer 7 is manufactured. A mold, having the shape of a ring with an inner diameter, which corresponds to the diameter of the felt layer 8 and with a height that exceeds the thickness of the felt layer 8 by more than 15 mm is provided. The mold is not shown in the figures. The felt layer 8 is then positioned within the mold and a given amount of liquefied silicone is poured onto the felt layer 8. The liquefied silicone is afterwards vulcanized and thereafter the mold is removed. In this way the drum pad 5, comprising the drum layer 6 and the felt layer 8, as shown in FIG. 2, is produced. The playing surface 7 of the drum layer 6 made of resilient material is ground afterwards in order to obtain a perfectly smooth surface so to avoid friction between the drum layer 6 and the sticks when the latter ones hit the playing surface.

Due to the drum layer 6 being manufactured by pouring liquefied silicone onto the upper side of the felt layer 8, the fibers of the upper region of the felt layer 8 are embedded in the silicone rubber of the lower region of the drum layer 6.

To obtain the drum practice device 1 shown in FIGS. 1 and 2, the wooden support frame 2 is provided. Glue is applied onto the lower side of the drum pad 5 and the drum pad 5 is positioned within the receiving space surrounded by the support frame 2.

It will be apparent to one of ordinary skill in the art that various modifications and variations can be made in construction or configuration of the present invention without departing from the scope or spirit of the invention. Thus, it is intended that the present invention cover all such modifications and variations, and as may be applied to the central features set forth above.

I claim:

1. Drum practice device (1) with a drum pad (5) having a drum layer (6) made of a resilient material with a planar playing surface (7) on its upper side, characterized in that the drum pad (5) comprises a felt layer (8) disposed beneath the drum layer (6).

2. Drum practice device according to claim 1, characterized in that the felt layer (8) is embodied as a needle felt layer and/or that the felt layer (8) comprises fibers made of polyester or polyamide.

3. Drum practice device according to claim 1, characterized in that the felt layer (8) comprises at least one fabric layer (9) to which at least one fiber layer (10) is affixed, particularly needled.

4. Drum practice device according to claim 1, characterized in that the felt layer (8) and/or the drum layer (6) have a thickness in the range of 5-15 mm, particularly of 8-12 mm.

5. Drum practice device according to claim 1, characterized in that the lower side of the felt layer (8) is coated or impregnated with a stiffening material, particularly epoxy resin or polyurethane or silicone, more particularly silicone rubber.

6. Drum practice device according to claim 1, characterized in that the felt layer (8) is disposed on, particularly affixed to, more particularly glued to the upper side of a support layer (3), which is particularly made of a rigid material, more particularly wood or plastic or metal, particularly that the support layer (3) has an upwardly projecting rim (4), which encloses the drum pad (5) at least partially, particularly wherein the drum pad (5) projects upwardly beyond the rim (4), particularly at least 2 mm.

7. Drum practice device according to claim 1, characterized in that the drum layer (6) is in full-area contact with the felt layer (8) over its entire lower surface, particularly that the drum layer (6) is embodied as a coating of the felt layer (8), and/or that the drum layer (6) is affixed to the felt layer (8), particularly that the fibers of at least the upper region of the felt layer (8) are embedded in at least the lower region of the drum layer (6).

8. Drum practice device according to claim 1, characterized in that a further layer is disposed between the drum layer (6) and the felt layer (8), and that the drum layer (6) is disposed on the further layer.

9. Drum practice device according to claim 1, characterized in that the drum layer (6) is made of silicone, particularly silicone rubber, particularly wherein the hardness of the silicone is in the range of 20-50 Shore A, more particularly of 30-40 Shore A.

10. Method for producing a drum practice device (1), comprising the steps of:
providing a felt layer (8),
providing a mold with a shape that corresponds to the contour of the felt layer (8), the mold having a height that exceeds the thickness of the felt layer (8),
positioning the felt layer (8) within the mold,
pouring a given amount of a liquefied resilient material, particularly liquefied silicone onto the felt layer (8) positioned within the mold,
vulcanizing the resilient material,
removing the mold.

11. Method for producing a drum practice device (1), comprising the steps of:
providing a felt layer (8),
coating the felt layer (8) with a resilient material;
vulcanizing the resilient material,
cutting or blanking out pieces out of the felt layer (8) coated with the resilient material, thus forming the drum pad (5).

12. Method according to claim 11, comprising the steps forming an endless belt out of a felt layer (8), coating the belt with the resilient material, open the endless belt by cutting it across its width thus forming a flat felt layer (8) coated with the resilient material and then cutting out the pieces.

13. Method according to one claim 10, comprising the further step of coating or impregnating the lower side of the felt layer (8) with a stiffening material, particularly epoxy resin or polyurethane or silicone, more particularly silicone rubber.

14. Method according to claim 10, comprising the further steps of disposing the felt layer (8) on, particularly affixing, more particularly gluing the felt layer (8) to the upper side of a support layer (3), which is particularly made of a rigid material, more particularly wood, plastic or metal, and/or grinding the playing surface (7).

15. Use of a pad according to claim 1, having at least a drum layer (6) made of a resilient material with a planar playing surface (7) on its upper side and a felt layer (8) disposed beneath the drum layer (6) as a drum pad (5) for a drum practice device (1).

16. Drum practice device according to claim 2, characterized in that the felt layer (8) comprises at least one fabric layer (9) to which at least one fiber layer (10) is affixed, particularly needled.

17. Drum practice device according to claim 2, characterized in that the felt layer (8) and/or the drum layer (6) have a thickness in the range of 5-15 mm, particularly of 8-12 mm.

18. Drum practice device according to claim 3, characterized in that the felt layer (8) and/or the drum layer (6) have a thickness in the range of 5-15 mm, particularly of 8-12 mm.

19. Drum practice device according to claim 2, characterized in that the lower side of the felt layer (8) is coated or impregnated with a stiffening material, particularly epoxy resin or polyurethane or silicone, more particularly silicone rubber.

20. Drum practice device according to claim 3, characterized in that the lower side of the felt layer (8) is coated or impregnated with a stiffening material, particularly epoxy resin or polyurethane or silicone, more particularly silicone rubber.
